(19) United States
(12) Patent Application Publication
(10) Pub. No.: US 2006/0044690 A1
(43) Pub. Date: Mar. 2, 2006

(54) Method and apparatus for manufacturing silicon sliders with reduced susceptibility to fractures

(76) Inventors: Nicholas Ian Buchan, San Jose, CA (US); Timothy Clark Reiley, San Jose, CA (US)

Correspondence Address: Chambliss, Bahner & Stophel, P.C.;Two Union Square, 1000 Tallan Building, Chattanooga, TN, 37402, US

(21) Appl. No.: 10/930,162

(22) Filed: Aug. 31, 2004

(51) Int. Cl. G11B 5/60

(52) U.S. Cl. 360/235.1

(57) ABSTRACT

A method and apparatus for manufacturing silicon sliders with reduced susceptibility to fracture of the substrate from which they are manufactured is disclosed. A monocrystalline silicon wafer is formed having an orientation in the {100} crystallographic plane. The silicon wafer includes a notch for orienting the silicon wafer, wherein the notch is formed substantially in the <100> direction. Sliders are formed from the silicon wafer.

### FIELD OF THE INVENTION

This disclosure relates in general to a magnetic storage systems, and more particularly to a method and apparatus for manufacturing silicon sliders with reduced susceptibility to fracture of the substrate from which they are manufactured.

### BACKGROUND

Hard disk drives utilizing magnetic data storage disks are used extensively in the computer industry. A head/disk assembly typically includes one or more commonly driven magnetic data storage disks rotatable about a common spindle. At least one head actuator moves one or more magnetic read/write heads radially relative to the disks to provide for reading and/or writing of data on selected circular concentric tracks of the disks. Each magnetic head is suspended in close proximity to one of the recording disks and supported by an air bearing slider mounted to the flexible suspension. The suspension, in turn, is attached to a positioning actuator.

During normal operation, relative motion between the head and the recording medium is provided by the disk rotation as the actuator dynamically positions the head over a desired track.

The relative motion provides an air flow along the surface of the slider facing the medium, creating a lifting force. The lifting force is counterbalanced by a known suspension load so that the slider is supported on a cushion of air. Air flow enters the leading edge of the slider and exits from the trailing end. The head normally resides toward the trailing end, which tends to fly closer to the recording surface than the leading edge.

Conventional magnetic recording head sliders are typically made from wafers of a two-phase ceramic, TiC/Al₂O₃, also called Al—TiC. After the thin film processing to prepare the recording heads is performed on the Al—TiC wafers, also called Al—TiC substrates, the sliders are then formed. The sliders are fabricated by cutting, grinding and lapping the wafer made of the above material. This involves a series of shaping and polishing operations, and also the formation of an air bearing, usually using dry etching, on the polished surface.

Silicon is being considered as a replacement for Al—TiC as a substrate material for recording heads of the future. Silicon sliders boast clear advantages including material cost, higher yield of sliders per substrate, several potential HDD advantages, and strategic advantages that may include active electronic devices within the slider.

Today, 125 mm diameter monocrystalline silicon substrates are most commonly oriented in the {100} crystallographic plane, although other orientations are available commercially. Compatibility of silicon substrates with existing magnetic recording head thin film manufacturing lines dictates that many of the mechanical dimensions be adopted from the specification for 125 mm diameter Al—TiC substrates. In addition, when working with silicon suppliers, it is most efficient to adopt a number of the conventions of the monocrystalline silicon specification, SEMI M1-0600 and the related specification SEMI M1.15-1000.

Also of importance, in both specifications, are the dimensions of the notch in the substrate that is used for orienting the substrate in manufacturing tools. For example, notch depth, radius and angle are specified for the pattern recognition systems on stepper lithography tools that use them for coarse alignment of the stepper. Indeed, the notch dimensions are identical in both specifications. However, in addition, SEMI M1-0600 specifies that the notch for {100} substrates be oriented in the <110> crystallographic direction, which is contained in the {110} and {111} primary cleavage planes of silicon. The notch is specified in this way so as to facilitate dicing of wafers by sawing after thin film processing. However, this specification contributes to increased fragility of the substrate in the manufacturing line, due to the tendency of notches to be the initiation site for fracture failure in brittle materials. Many operations use the notch for wafer positioning, in which case the mechanical interaction with a pin or guidepost can lead to chipping locally at the notch. A compounding factor is that the easiest fracture path for a circular wafer under point-load induced bending stress is along the diameter, which in the case of the <110> oriented notch, is in the <110> direction. Both primary cleavage fracture planes in a silicon wafer can be activated in this direction, making this diameter particularly vulnerable, when coupled with a potential fracture initiation point.

Magnetic recording head thin film manufacturing lines have been configured to work with the more robust Al—TiC substrates. As a result, in the aforementioned manufacturing lines, silicon substrates that use the SEMI M1-0600 standard specification for the notch have shown a wafer yield that is lower than desired. These substrates are susceptible to fracture, which is initiated at the notch, breaking the substrates into at least two pieces, thereby rendering the substrate worthless.

Thus, although many tools in thin film manufacturing lines can readily process silicon substrates without wafer breakage or chipping at the notch, other tools impart stresses to the notch that result in fracture of silicon wafers (as opposed to Al—TiC wafers) and thus yield loss. Costly retooling of the manufacturing line may circumvent this problem. However, a costless yield-improving change in the specification of the silicon substrate is needed.

It can be seen that there is a need for a method and apparatus for manufacturing silicon substrates with reduced susceptibility to fractures.

### SUMMARY OF THE INVENTION

To overcome the limitations in the prior art described above, and to overcome other limitations that will become apparent upon reading and understanding the present specification, the present invention discloses a method and apparatus for manufacturing silicon substrates with reduced susceptibility to fracture.

The present invention solves the above-described problems by providing improved wafer robustness and projecting a substantial yield improvement in future manufacturing using a silicon wafer notch in the <100> direction for {100} oriented silicon substrates.

A silicon wafer in accordance with the principles of the present invention includes a {100}-oriented monocrystalline substrate and a notch oriented substantially in the <100> crystallographic direction for positioning the wafer.

In another embodiment of the present invention, a wafer is provided from which a plurality of silicon sliders may be cut, wherein the silicon wafer is oriented in the {100} crystallographic plane and includes a notch oriented substantially in the <100> direction.

In another embodiment of the present invention, a magnetic storage system is provided. The magnetic storage system includes at least one magnetic storage medium, a motor for moving the at least one magnetic storage medium, at least one slider for flying over the data surface of the at least one magnetic storage medium and an actuator, coupled to the slider, for positioning the slider relative to the at least one magnetic storage medium, wherein the slider is manufactured from a silicon wafer oriented in the {100} crystallographic plane having a notch oriented substantially in the <100> direction.

In another embodiment of the present invention, a method of forming a silicon wafer having a crystallographic orientation in the {100} crystallographic plane is provided. The method includes growing a single crystal silicon ingot having a {100} oriented monocrystalline structure, determining the crystallographic orientation of the ingot, forming a notch having an orientation substantially in the <100> direction in the single crystal silicon ingot and slicing the silicon ingot into individual wafers.

In another embodiment of the present invention, another method of forming a silicon wafer having a crystallographic orientation in the {100} crystallographic plane is provided. This method includes forming a {100} oriented monocrystalline silicon wafer of silicon, determining the crystallographic orientation of the wafer, and forming a notch having an orientation substantially in the <100> direction in the side of the {100} oriented monocrystalline silicon wafer.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 is a plan view of a disk drive according to the present invention;

FIG. 2 is a perspective view of actuator assembly;

FIG. 3 illustrates a greatly enlarged view of a head gimbal assembly;

FIG. 4 illustrates a silicon ingot having a crystal orientation in the {100} direction according to an embodiment of the present invention;

FIG. 5 illustrates a {100} oriented silicon substrate;

FIG. 6 illustrates a notch in monocrystalline silicon or AlTiC substrates;

FIG. 7a shows lattice planes and directions of the silicon lattice, as described by the mathematical description known as the Miller Indices and relates them to the {100} oriented monocrystalline wafer (or substrate) having a notch oriented in a <110> direction according to the specification SEMI M1-0600 and the related specification SEMI M1.15-1000;

FIG. 7b shows lattice planes and directions of the silicon lattice, and relates them to the {100} oriented monocrystalline wafer (or substrate) having a notch orientation in the <100> direction according to an embodiment of the present invention; and

FIG. 8 is a flow chart of a method for manufacturing silicon substrates with reduced susceptibility to fracture according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method and apparatus for manufacturing silicon sliders with reduced susceptibility to fracture of the substrates from which they are made. Improved wafer robustness and a substantial yield improvement in future manufacturing is provided using a silicon wafer notch substantially in the <100> direction for {100} oriented silicon substrates.

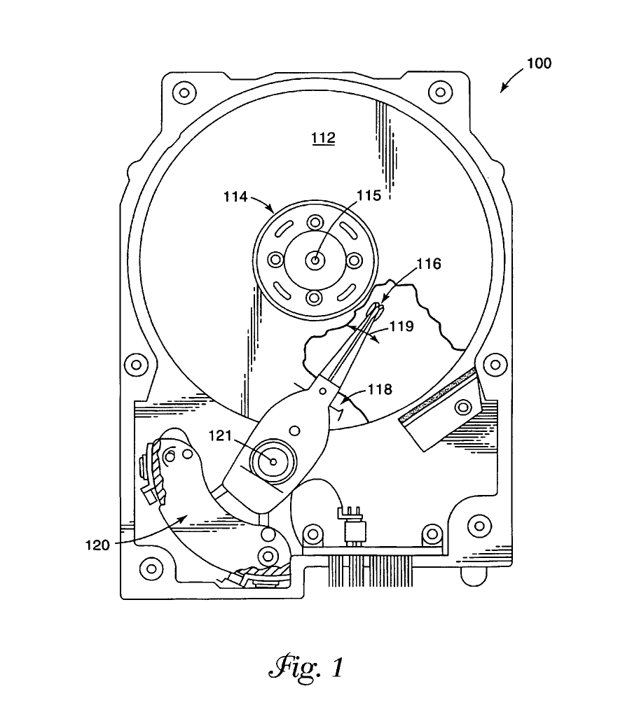

FIG. 1 is a plan view of a disk drive 100 according to the present invention. Disk drive 100 includes a disk pack 112, which is mounted on a spindle motor (not shown) by a disk clamp 114. Disk pack 112, in one preferred embodiment, includes a plurality of individual disks that are mounted for co-rotation about a central axis 1115. Each disk surface on which data is stored has an associated head gimbal assembly (HGA) 116, which is mounted to an actuator assembly 118 in disk drive 100. The actuator assembly shown in FIG. 1 is of the type known as a rotary moving coil actuator and includes a voice coil motor (VCM) shown generally at 120. Voice coil motor 120 rotates actuator assembly 118 with its attached head gimbal assemblies (HGAs) 116 about a pivot axis 121 to position HGAs 116 over desired data tracks on the associated disk surfaces, under the control of electronic circuitry housed within disk drive 100.

More specifically, actuator assembly 118 pivots about axis 121 to rotate head gimbal assemblies 116 generally along an arc 119, which causes each head gimbal assembly 116 to be positioned over a desired one of the tracks on the surfaces of disks in disk pack 112. HGAs 116 can be moved from tracks lying on the innermost radius, to tracks lying on the outermost radius of the disks. Each head gimbal assembly 116 has a gimbal that resiliently supports a slider relative to a load beam so that the slider can follow the topography of the disk. The slider, in turn, includes a transducer that is utilized for encoding flux reversals on, and reading flux reversals from, the surface of the disk over which it is flying.

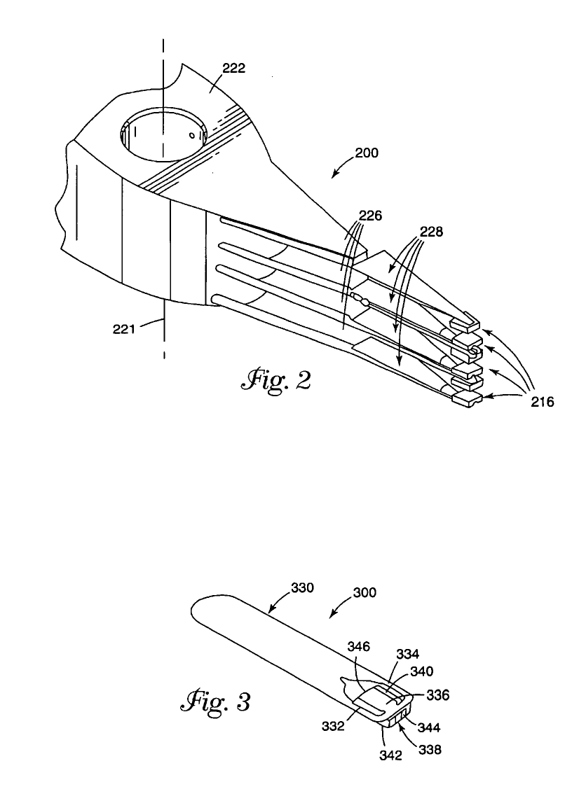

FIG. 2 is a perspective view of actuator assembly 200. Actuator assembly 200 includes base portion 222, a plurality of actuator arms 226, a plurality of load beams 228, and a plurality of head gimbal assemblies 216. Base portion 222 includes a bore, which is, in the preferred embodiment, coupled for pivotal movement about axis 221. Actuator arms 226 extend from base portion 222 and are each coupled to the first end of either one or two load beams 228. Load beams 228 each have a second end that is coupled to a head gimbal assembly 216.

FIG. 3 illustrates a greatly enlarged view of a head gimbal assembly 300. Head gimbal assembly 300 includes gimbal 330, which has a pair of struts 332 and 334, and a gimbal bond tongue 336. Head gimbal assembly 300 also includes slider 338, which has an upper surface 340, and a lower, air bearing surface 342. Transducers 344 are also preferably located on a trailing edge of slider 338. The particular attachment between slider 338 and gimbal 330 is accomplished in any desired manner. For example, a compliant sheer layer may be coupled between the upper surface 340 of slider 338 and a lower surface of gimbal bond tongue 336, with an adhesive. A compliant sheer layer permits relative lateral motion between slider 338 and gimbal bond tongue 336. Also, gimbal bond tongue 336 preferably terminates at a trailing edge of slider 338 with a mounting tab 346 which provides a surface at which slider 338 is attached to gimbal bond tongue 336. As mentioned earlier, silicon is being considered as a replacement for AlTiC as a substrate material for recording heads of the future. Thus, future generations of magnetic recording head slider bodies 338 may be made of silicon.

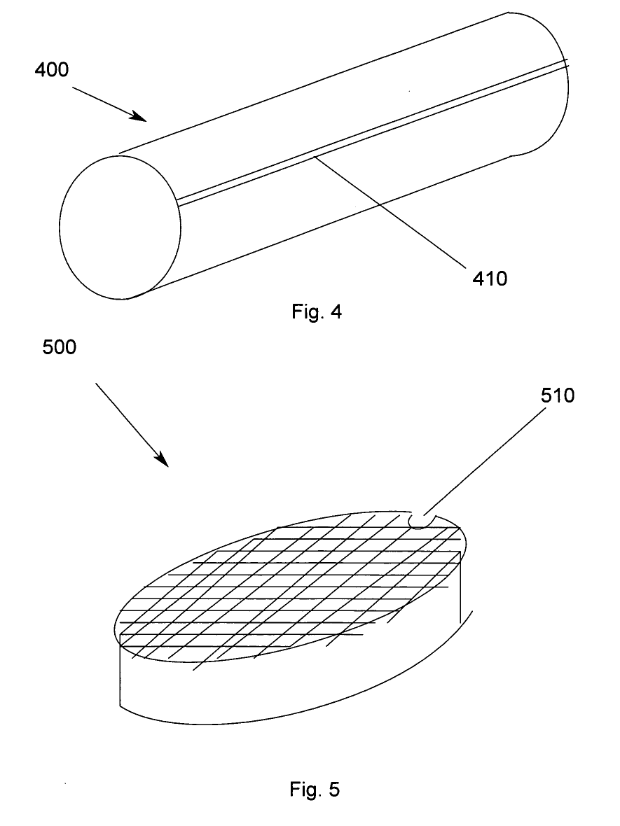

FIG. 4 illustrates a silicon ingot 400 having a crystal orientation in the {100} plane according to an embodiment of the present invention. The silicon ingot 400 is used to produce a silicon wafer. The ingot 400 may be cut to a specified length, and the periphery is ground to the specified diameter. A notch 410 is added to a part of the periphery to indicate the crystal orientation. According to the present invention, the notch 410 is formed in the <100> direction. Those skilled in the art will recognize that the notch 410 may comprise any marker for positioning the ingot 400. The ingot 400 is then sliced into wafers one by one.

FIG. 5 illustrates a {100} oriented silicon substrate 500. As can be seen the wafer includes a notch 510. The position of the notch 510 has in the past been selected per the specification SEMI M1-0600 and the related specification SEMI M1.15-1000, i.e., oriented in a <110> direction. However, according to the present invention, the notch 410 is formed in the <100> direction.

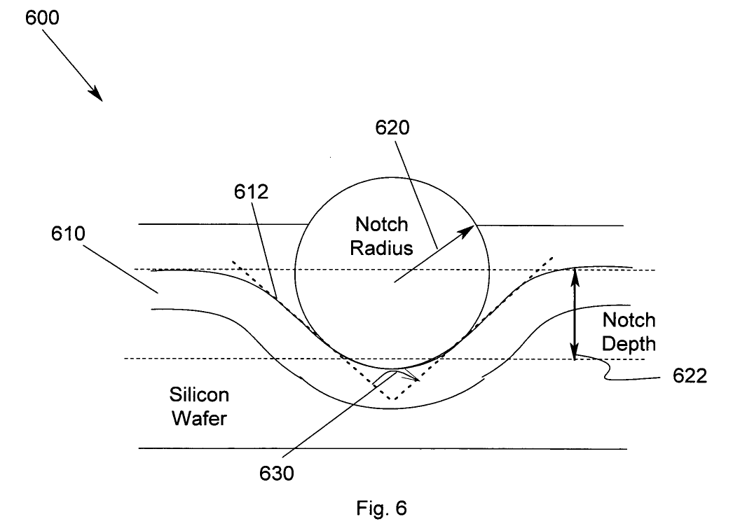

FIG. 6 illustrates the dimensions of a notch 600 in monocrystalline silicon or AlTiC substrates. In FIG. 6, the silicon wafer 610 has a notch 612 cut therein. The notch 612 has a radius 620 and depth 622 as shown. The dimensions of the notch 612 in the substrate 610 are used for orienting the substrate 610 in manufacturing tools. For example, notch depth 622, radius 620 and angle 630 are specified for the pattern recognition systems on stepper lithography tools that use them for coarse alignment of the stepper.

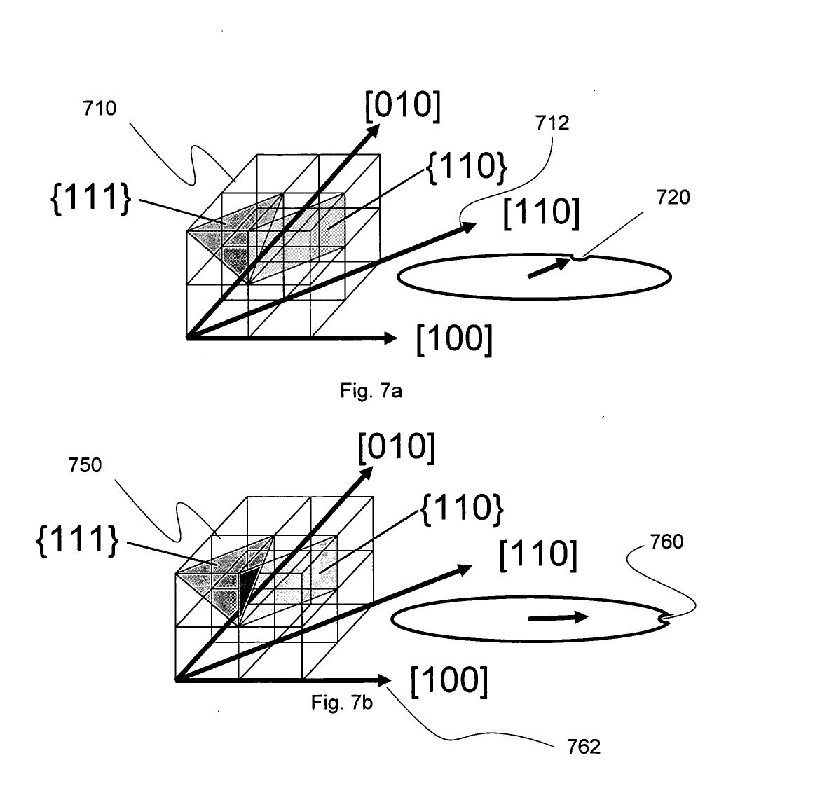

FIGS. 7a-b show the modifications to the orientation of the silicon wafer notch according to an embodiment of the present invention. FIG. 7a shows crystallographic orientations in a {100} oriented monocrystalline substrate 710. In order to discuss a particular plane of atoms or a crystal face within the crystal lattice structure, a universally accepted system of indices has been developed to describe the orientation of crystallographic planes and crystal faces relative to crystallographic axes. This convention is called the system of Miller indices. Miller Indices are a symbolic vector representation for the orientation of an atomic plane in a crystal lattice and are defined as the reciprocals of the fractional intercepts that the plane makes with the crystallographic axes. In FIG. 7a, the orientation 712 of the notch 720 is selected, per the specification SEMI M1-0600 and the related specification SEMI M1.15-1000, in a <110> direction.

However, as described earlier, orientation of the notch in the <110> direction increases the fragility of the substrate due to the tendency of notches to be the initiation site for fracture failure in brittle materials. It turns out that the easiest fracture path for a circular silicon wafer under point-load induced bending stress is along the diameter, which in the case of the <110> oriented notch 720, is in the <110> direction 712. Both primary cleavage fracture planes in a silicon wafer can be activated in this direction, making this diameter particularly vulnerable, when coupled with a potential fracture initiation point. Accordingly, silicon substrates that use the SEMI M1-0600 standard specification for the notch 720 in the <110> direction 712 exhibit a wafer yield that is lower than desired. These substrates are susceptible to fracture which is initiated at the notch 720 in the <110> direction 712, breaking the substrates into at least two pieces, thereby rendering them worthless.

FIG. 7b illustrates a notch orientation in the <100> direction according to an embodiment of the present invention. FIG. 7b also shows crystallographic orientations in a {100} oriented monocrystalline substrate 750. The direction of the notch is selected to decrease susceptibility of fracture of the silicon wafer. As shown in FIG. 7b, the position of the notch 760 is selected in a <100> direction 762 and is thus rotated 45 degrees from the orientation specified by SEMI M1-0600. By using a notch 760 having an orientation in the <100> direction 762, improved robustness to manufacturing processes is achieved. The notch may therefore be used for positioning in many different types of manufacturing devices including, for example, a lithographic apparatus. The improved robustness to manufacturing processes minimizes fractures that result from the prominent cleavage geometry of silicon.

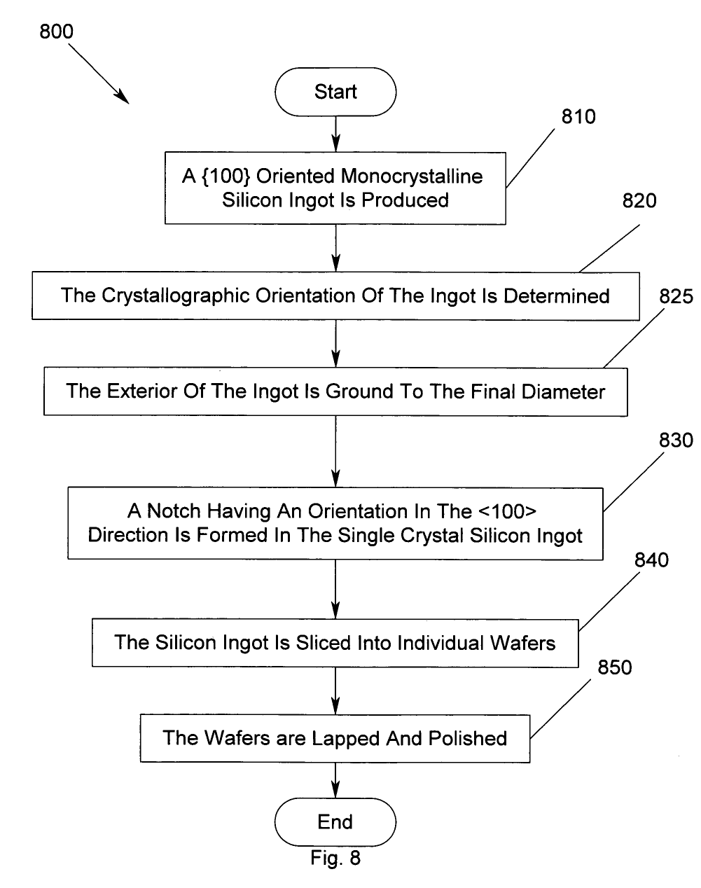

FIG. 8 is a flow chart 800 of a method for manufacturing silicon substrates with reduced susceptibility to fracture according to an embodiment of the present invention. In FIG. 8, an ingot in which the circular cross-section of the monocrystalline silicon ingot is located in the {100} plane, heretofore referred to as the {100} oriented monocrystalline silicon ingot, is produced 810. The orientation of crystallographic planes and crystal faces relative to crystallographic axes is determined 820. The exterior of the ingot is ground to produce the final diameter 825. A notch having an orientation in the <100> direction is created in the side of the {100} oriented monocrystalline silicon ingot 830. The silicon ingot is sliced into individual wafers 840. The wafers are lapped and polished 850. In an alternative embodiment, the notch may not be added until the ingot is sliced into individual wafers.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A silicon wafer comprising:
a {100}-oriented monocrystalline substrate; and
a notch oriented substantially in the <100> crystallographic direction for positioning the wafer.

2. The silicon wafer of claim 1, wherein the direction of the notch substantially in the <100> crystallographic direction decreases susceptibility of fracture of the silicon wafer.

3. The silicon wafer of claim 1, wherein the notch substantially in the <100> direction is chosen so as not to be contained in a preferred cleavage fracture plane of the silicon wafer.

4. The silicon wafer of claim 1, wherein the notch is oriented in the <100> crystallographic direction ±15 degrees.

5. The silicon wafer of claim 1, wherein the direction of the notch is selected as a position rotated 45 degrees from the orientation specified by SEMI M1-0600.

6. A silicon wafer from which a plurality of silicon sliders may be created, wherein the silicon wafer is oriented in the {100} crystallographic plane and includes a notch oriented substantially in the <100> direction.

7. The silicon wafer of claim 6, wherein the direction of the notch substantially in the <100> direction decreases susceptibility of fracture of the silicon wafer.

8. The silicon wafer of claim 6, wherein the notch substantially in the <100> direction is chosen so as not to align with a preferred cleavage fracture plane of the silicon wafer.

9. The silicon wafer of claim 6, wherein the notch is oriented in the <100> crystallographic direction ±15 degrees.

10. The silicon wafer of claim 6, wherein the direction of the notch is selected as a position rotated 45 degrees from the orientation specified by SEMI M1-0600.

11. A magnetic storage system, comprising at least one magnetic storage medium;
a motor for moving the at least one magnetic storage medium;
at least one slider for flying over the data surface of the at least one magnetic storage medium; and
an actuator, coupled to the slider, for positioning the slider relative to the at least one magnetic storage medium;
wherein the slider is manufactured from a silicon wafer oriented in the {100} crystallographic plane having a notch oriented substantially in the <100> direction.

12. The magnetic storage system of claim 11, wherein the direction of the notch substantially in the <100> direction in the wafer used to manufacture the silicon slider decreases susceptibility of fracture of the silicon wafer.

13. The magnetic storage system of claim 11, wherein the notch substantially in the <100> direction is chosen so as not to be contained in a preferred cleavage fracture plane of the silicon wafer.

14. The magnetic storage system of claim 11, wherein the notch is oriented in the <100> crystallographic direction ±15 degrees.

15. The magnetic storage system of claim 11, wherein the direction of the notch is selected as a position rotated 45 degrees from the orientation specified by SEMI M1-0600.

16. A method of forming a silicon wafer having a crystallographic orientation in a {100} plane, comprising:
growing a single crystal silicon ingot having a {100} oriented monocrystalline structure;
determining the crystallographic orientation of the ingot; grinding the periphery of the ingot;
forming a notch having an orientation substantially in the <100> direction in the single crystal silicon ingot; and
slicing, lapping and polishing the silicon ingot into individual wafers.

17. The method of claim 16, wherein forming the notch substantially in the <100> direction decreases susceptibility of fracture of the silicon wafer.

18. The method of claim 16, wherein forming the notch substantially in the <100> direction further comprises choosing to form the notch so as not to align with a preferred cleavage fracture plane of the silicon wafer.

19. The method of claim 16, wherein forming the notch in the <100> direction further comprises forming the notch in the <100> crystallographic direction ±15 degrees.

20. The method of claim 16, wherein forming the notch in the <100> direction further comprises selecting a position for the notch that is rotated 45 degrees from the orientation specified by SEMI M1-0600.

21. A method of forming a silicon wafer having a crystallographic orientation in a {100} plane, comprising:
forming a {100} oriented monocrystalline silicon wafer of silicon;
determining the crystallographic orientation of the wafer; and
forming a notch having an orientation substantially in the <100> direction in the side of the {100} oriented monocrystalline silicon wafer.

22. The method of claim 21, wherein forming the notch substantially in the <100> direction decreases susceptibility of fracture of the silicon wafer.

23. The method of claim 21, wherein forming the notch substantially in the <100> direction further comprises choosing to form the notch so as not to be contained in a preferred cleavage fracture plane of the silicon wafer.

24. The method of claim 21, wherein forming the notch in the <100> direction further comprises forming the notch in the <100> crystallographic direction ±15 degrees.

25. The method of claim 21, wherein the forming the notch in the <100> direction further comprises selecting a position for the notch that is rotated 45 degrees from the orientation specified by SEMI M1-0600.
